(19) United States
(12) Patent Application Publication
(10) Pub. No.: US 2007/0007770 A1
(43) Pub. Date: Jan. 11, 2007

(54) Mechanical energy recovery device with variable stiffness

(75) Inventors: Thomas Jager, Grenoble (FR); Jean-Jacques Chaillout, Saint-Etienne-De-Crossey (FR); Ghislain Despesse, Saint Christophe (FR); Andrea Vassilev, Ampere (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/473,176

(22) Filed: Jun. 23, 2006

(30) Foreign Application Priority Data
Jun. 30, 2005 (FR) 05 51851

(51) Int. Cl. H02K 7/18; F03G 7/08; F02B 63/04

(52) U.S. Cl. 290/1 R

(57) ABSTRACT

In an energy recovery system based on relative movement between a fixed part and a mobile part connected by flexible connecting means, the flexible link is made so as to provide variable mechanical stiffness, for example due to the presence of repulsive elements or use outside the linear range. Thus, more compact vibrational mechanical energy recovery systems can be made, with a widened usage range, that are more robust than existing systems.

### TECHNICAL FIELD

This invention relates to systems capable of recovering energy from movements in their environment (vibrations, impacts, flows, etc.) based on the principle of a suspended mass making relative movements with respect to this environment.

More specifically, in order to adapt to environments in which vibration and/or deformation amplitudes are not fixed, the invention relates to recovery systems in which the means of connecting the suspended mass to the fixed part react to an action in a non-linear manner: in particular, the two parts free to move relative to each other are connected by variable stiffness springs.

### STATE OF PRIOR ART

The principle of energy generation due to relative movement between two devices is known for example in document EP-A-0 008 237. It has been applied to the recovery of energy from a mobile system, for example in document GB-A-2 311 171; a base (usually external) is rigidly fixed (by screwing, gluing, etc.) to a moving support, and a mobile part (usually internal) is connected to the fixed base through a flexible link. Due to its inertia, the suspended mobile part makes a relative displacement with respect to the fixed part and therefore to the support; a converter transforms the recovered mechanical energy into any required form of energy (electrical, thermal, mechanical, etc.), using any type of conversion. For example, the conversion principle for electrical converters may be electromagnetic, capacitive, electrostatic, piezoelectric or other.

Thus FIG. 1 illustrates a specific example related to conversion of mechanical energy into electrical energy using the piezoelectric principle. The device 1 comprises a housing 2 fixed to a support 3 that is vibrated. An energy conversion system is located inside the housing 2 and consists of a mass 4 connected to the housing 2 through a beam 5 made at least partially from a piezoelectric material, this connection allowing freedom of movement of the mass; the beam is fixed to (built in) the housing 2 at its first end and is free at its second end. The relative displacement of the mass 4 with respect to the housing 2 modifies the piezoelectric value of the beam 5 and the electrical energy thus generated may be transmitted to an operating system 7 through a connection 6.

In conventional structures, the flexible connecting means are sized to react optimally to a given range of vibrations: in general, elastic deformation of mechanical elements such as beams, springs, or membranes, remains within their linear deformation range. The connecting elements are thus chosen appropriately as a function of the vibration and deformation amplitude expected from the environment. In particular, deformation of the connecting means is directly proportional to the applied force, in other words it is proportional to the acceleration of the movement of the device.

For example, for the built-in and guided beam 5 in FIG. 1, the relation between the displacement x of the end 4 of the beam and the force S applied at its guided end 5 is given by

$$F = \frac{12 \cdot E \cdot I}{{L}^{3}} \cdot x ,$$

where L is the length of the beam 5, E is its Young's Modulus and I is its moment of inertia about its bending axis.

It can quickly be seen that this type of structure becomes inefficient or even unusable in environments in which parameters are different from the expected values: in the previous example, a deformation amplitude and an acceleration that are too high will result in a displacement of the end 4 such that it stops in contact with the housing 2, thus forming a physical limit to the displacement. High energy is also dissipated during impacts, that can irreversibly damage the conversion system.

### PRESENTATION OF THE INVENTION

The invention is intended to overcome these disadvantages of existing devices, and its advantages include the elimination of constraints related to the environment. Thus, the invention can increase the application scope of a determined energy recovery device with a fixed size.

To achieve this, the invention relates to the addition of elements with a non-linear mechanical behavior, particularly variable stiffness. Apart from a wider application field, energy recovery structures according to the invention can be sized so as to make them more compact.

In one of its aspects, the invention relates to an energy recovery system comprising two parts connected to each other while remaining free to move with respect to each other, one of the parts possibly being rigidly connected to a support from which energy is recovered. Advantageously, means capable of conversion of energy generated by relative movement of the two parts are provided, which preferably comprise an electronic element to exploit the electrical preferably energy. The geometry of the device preferably includes a housing in which there is a suspended part which is relatively mobile; either the housing or the suspended part may be connected rigidly to a support.

The flexible connecting means between the two parts are such that a deformation of said means following a mechanical action is non-linear within a use range, and in particular is increasing. In particular, the flexible connecting means may consist of a spring-like element with a variable stiffness. It is also possible to associate an element acting as a spring, which has a constant or variable stiffness or combines the two characteristics, with a repulsive element.

In this way, when the vibration amplitude of an environment with which the device is associated during use exceeds a certain value, the stiffness of the flexible link quickly increases and the displacement of the mobile part no longer follows a linear profile: it is possible to have a smaller device than usual. Note that it is not known to use the non-linear reaction property for this purpose.

According to another aspect, the invention relates to a method for recovering energy generated from an environment in which a device comprising two parts connected to each other through a flexible link is fixed to the environment by one of the two parts, and in which the second part of the device is moved by exertion of first amplitude vibrations or deformations on the environment, the method being such that the first amplitude goes beyond the linearity range of the flexible connecting link. The link may include spring-like means, associated or not with a repulsive element.

### BRIEF DESCRIPTION OF THE FIGURES

The specific features and advantages of the invention will be better understood after reading the following description with reference to the appended figures, given for illustration and in no way limitative.

FIG. 1, already described, illustrates a known device for the recovery of mechanical energy by a piezoelectric principle.

FIG. 2 shows a device according to the invention.

FIGS. 3A and 3B diagrammatically show advantages obtained with a device according to the invention.

FIGS. 4A and 4B show another embodiment of a device according to the invention.

### DETAILED PRESENTATION OF PARTICULAR EMBODIMENTS

A device 10 according to the invention, illustrated for example in FIG. 2, comprises as usual a fixed part 12 connected to the mechanical energy source, in this case a support 14 to which vibrations are applied, a mobile part 16 and energy conversion elements 18: due to its inertia, the mobile part 16 is put into relative movement with respect to the fixed part 12 as soon as this fixed part is subjected to an external acceleration, applied onto the support 14 (double arrow); the energy of this movement is transformed and is recovered due to the mechanical energy conversion elements 18.

The conversion elements 18 may be based on different principles, for example electrostatic, electromagnetic, piezoelectric or magnetostrictive conversions, illustrated particularly in document FR 2 872 868.

The fixed part 12 and the mobile part 16 are connected by a flexible link 20. This invention proposes to choose elements 20 for the flexible link that do not respond linearly to the displacement loads, particularly elements with an increasing mechanical stiffness, to extend the operating range of the device 10.

Thus, within the scope of the invention, the mechanical stiffness of the flexible mechanical elements 20 increases as a function of the movement amplitude of the mobile part 16 with respect to the fixed part 12, high external accelerations can be absorbed without damage by the structure 10, the mechanical links 20 becoming increasingly stiff as the movement amplitude increases and the resulting generated displacement becomes smaller. According to the invention, the non-linear means form an integral part of the device 10, and not added shock absorption means, in that they replace the conventional connecting spring.

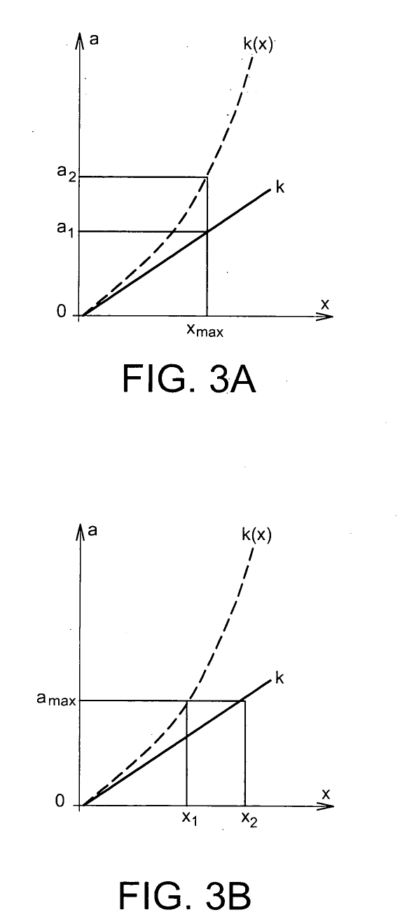

Two effects in particular may be derived from this selection for the connecting elements 20. As shown on FIG. 3A, for a device 10 for which the maximum displacement amplitude xₘₐₓ of the mobile part 16 with respect to the fixed part 12 is fixed, for example due to a possible stop of the mobile part 16 on the fixed part 12, the operating range of the mechanical energy recovery device 10 is higher than in a structure 1 using mechanical connections with constant stiffness k: the maximum allowable acceleration of the environment 14 before colliding with the limit stop changes from a₁ to a₂.

Conversely, as shown in FIG. 3B, for an environment 14 for which an operating range that gives a maximum amplitude aₘₐₓ can be determined, it becomes possible to reduce the dimensions of the structure 10 due to the reduced amplitude of the relative movement x that decreases from x₂ to x₁ due to the use of the mechanical connection with variable stiffness k(x).

Mechanical elements 20 with variable stiffness k(x) may be made in several ways. For example, the flexible connecting means 20 can be appropriately mechanically sized so that the non-linear deformation range of their material can be used.

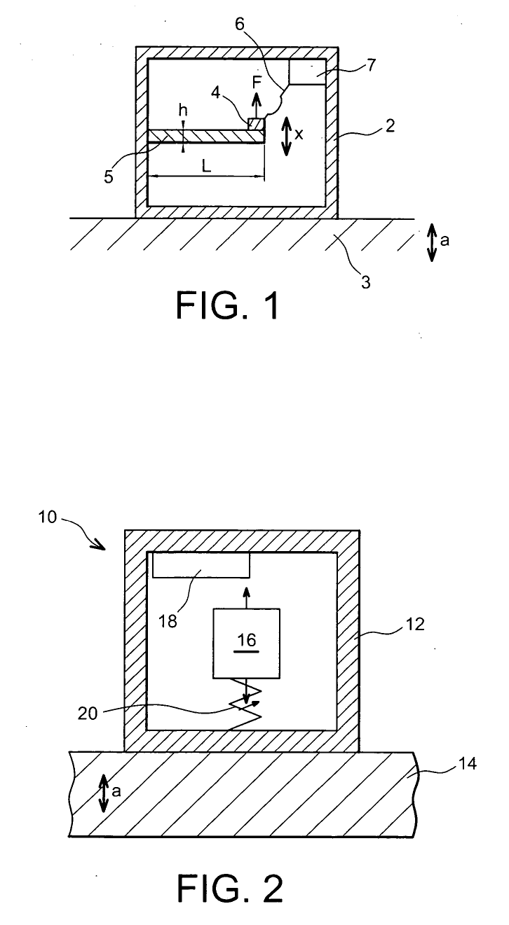

Thus, for simple deformation elements for example such as beams or membranes, it is usually considered that the linear deformation range is exceeded as soon as the imposed deformation becomes greater than the thickness of the deformed structure 20: for a built-in guided beam like that illustrated in FIG. 1, the stiffness k(x) increases quickly with the deformation as soon as the displacement x at end 4 exceeds the thickness h of the beam 5. Thus, according to the invention, a beam 20 can be chosen for which the thickness h is less than the predicted displacements.

Conversely, a predetermined device 10 can be used in an environment 14 such that the vibrations generate oscillations with an amplitude x greater than the thickness h. Another option is to use spring-like elements 20 outside their linear elasticity range.

These variable stiffness elements may be made in many ways. In the context of a macroscopic system occupying a few cubic centimeters the beams used as springs may for example be made by cutting a conducting material (for example tungsten, gold or steel) by spark machining at the same time as the entire mechanical energy to electrical energy conversion structure. For a microscopic conversion system made using microelectronic technologies, the spring elements (typically beams or membranes) may be made for example of silicon etched by different techniques (for example DRIE dry etching or wet etching) using a well-defined mask.

Their typical dimension is of the order of 1 μm. Therefore their stiffness is non-linear for deformations of several times their thickness (several micrometers).

Furthermore, a flexible link can be chosen for the device 10 comprising an element acting as a spring for which the stiffness increases with the displacement, uniformly if possible, and particularly over the entire range of actions. Various options are presented in document US 2004/061412.

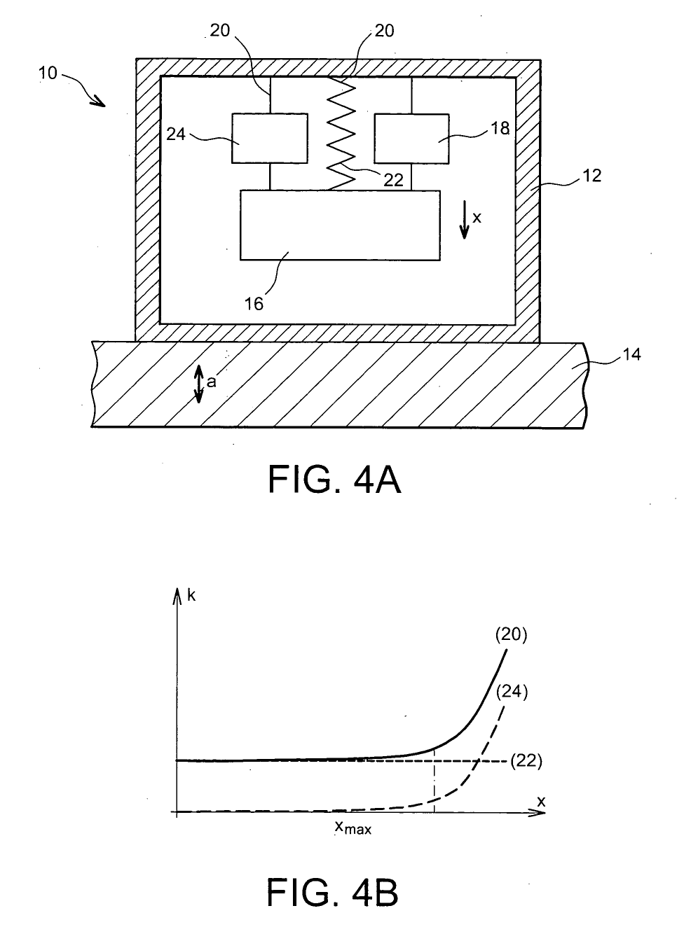

Another embodiment for the flexible mechanical link with variable stiffness 20 is the use of common means, for example spring-like means 22, combined with at least one additional element 24 that will act in repulsion when moving close to the maximum allowable deformation amplitude xₘₐₓ; see FIGS. 4A and 4B. The apparent stiffness k of the flexible connecting means 20 is the sum of stiffnesses output from the spring-like element 22 and repulsive elements 24, that increase with the displacement.

The repulsive element 24 may be based on different principles. For example, the element 24 may cause repulsion between the fixed element 12 and the mobile element 16 close to xₘₐₓ by means of electrostatic, electromagnetic, piezoelectric, hydraulic, pneumatic or combined forces.

For example, repulsive magnetic elements such as magnets placed or glued on the fixed and mobile parts of the structure and in which poles of the same nature (N or S) are arranged to face each other, may be transferred onto the conversion structure. Thus, as these elements move closer towards each other, the repulsion force applied between them will increase. This force, combined with the purely mechanical return force, globally forms a deformation element with variable stiffness.

For example, it will also be possible to envisage the use of piezoelectric material in the mechanical deformation elements of the structure (for example in the case of microstructures, a film of a piezoelectric material can be made for covering mechanical deformation elements such as beams or membranes). During the deformation, it is then sufficient to charge the piezoelectric element such that it is subjected to a piezoelectric force opposing the movement of the structure (for example it can be charged when the deformation exceeds a given value close to the maximum deformation amplitude allowable by the mechanical structure). Since this piezoelectric force is added to the purely mechanical return force at an appropriate moment, this technique can be used to make a mechanical deformation element with stiffness which varies as a function of the displacement amplitude.

Naturally, the two embodiments can be combined and for example a repulsive element 24 can be added to connecting means sized such that the stiffness is not constant throughout the vibration range, so as to associate operation in the non-linear deformation range to the threshold effect of the repulsive element 24.

Although described in the conventional configuration, the connection with a variable mechanical stiffness according to the invention can be associated with an <<inverted>> configuration at the masses of the energy recovery device as described in document FR 2 872 868: in this configuration, the housing 12 forms the mobile part and the second part 16 is connected to the support 14 through a rigid link passing through the housing 12.

The use of flexible links with variable mechanical stiffness according to the invention can result in more compact vibrational mechanical energy recovery systems with a broader use range, and that are more robust than existing systems. In particular, the non-linearity effect which is used continuously can increase the operating range of the system to more efficiently recover energy from low frequency and/or high amplitude movements.

1. Device for recovery of energy from a moving environment, said device comprising a first part and a second part free to move with respect to each other and first means for connecting the first part to the second part in a mobile manner, wherein the deformation ratio of first means as a function of the applied force is non-linear over a use range.

2. Device according to claim 1 wherein the deformation ratio of the first means is increasing as a function of the force applied.

3. Device according to claim 1, wherein the first means comprise a spring-like element with variable stiffness.

4. Device according to claim 1 wherein the first means comprise a spring-like element and an element than can apply a repulsion face.

5. Device according to claim 2, wherein the first means comprise a spring-like element possibly associated with an element that can apply a repulsion force.

6. Device according to claim 1 further comprising elements for converting the energy output from the relative movement of the first and second parts.

7. Device according to claim 1 wherein either the first or second part is a housing containing the other of the first and second parts.

8. Device according to claim 7 comprising second means passing through the housing so as to rigidly connect the other of the first and second parts to a support.

9. Device according to claim 7 wherein the first means comprise a spring-like element.

10. Method of recovering mechanical energy from an environment, including:
placement of a device comprising two parts which move relatively to each other, so that one of the parts is coupled to the environment, the two parts in the device being connected to each other by flexible connecting means;
moving of the environment by a first amplitude of vibrations and/or deformations;
such that the connecting means respond non-linearly to the force generated by the first amplitude.

11. Method according to claim 10 wherein the flexible connecting means comprise a spring-like element, the stiffness of which is not constant within the range of the first amplitude.

12. Method according to claim 10 wherein the flexible connecting means comprise first spring-like means and second repulsive means.

13. Use of a device as claimed in claim 1 by coupling either the first or second part to an environment that can be vibrated with an amplitude such that the first connecting means do not react linearly to vibrations.

14. Device for recovering energy from a moving environment comprising a housing and a mass which are movable relative to each other and which are connected through an element whose deformation ratio as a function of applied force is not linear over a use range.

15. Device according to claim 14 comprising connecting means for connecting the mass rigidly to a support through the housing.

16. Device according to claim 14 wherein the connecting element comprises a spring.

17. Device according to claim 16 wherein the connecting element further comprises a repulsion element.

18. Device according to claim 15 further comprising means for converting the energy output from the relative movement of the mass and the housing.
